(19) United States
(12) Patent Application Publication
(10) Pub. No.: US 2026/0310612 A1
(43) Pub. Date: Oct. 8, 2026

(54) EFFICIENT LOADING OF AN ARTIFICIAL INTELLIGENCE MODEL USING CACHE AND STORAGE IDENTIFIED DEDUPLICATION

(71) Applicant: Dell Products L.P., Round Rock, TX (US)

(72) Inventors: Jonathan Peter Streete, South San Francisco, CA (US); Erik Philip Smith, Douglas, MA (US); Mihai Lazar, Ottawa (CA); Keyur Desai, Cary, NC (US); Claudio DeSanti, Santa Cruz, CA (US)

(21) Appl. No.: 19/173,482

(22) Filed: Apr. 8, 2025

(51) Int. Cl. G06F 12/14; G06F 13/42

(52) U.S. Cl. CPC G06F 12/14; G06F 13/4282; G06F 2212/1052; G06F 2213/0026

(57) ABSTRACT

A method for managing data includes: sending, by a PU of a first server, a read request for a data block to a first DPU of the first server; making, by the first DPU, a first determination that the data block is not present in a first cache of the first DPU; sending, by the first DPU, the read request to an SS; making, by the SS, a second determination that the data block is not present in a second cache of a second DPU of the second server; sending, by the SS, the data block along with a token to the first DPU; storing, by the first DPU, the data block and the token to the first cache until the data block needs to be evicted from the first cache; and sending, by the first DPU, the data block to the PU.

### BACKGROUND

The training of a machine learning (ML)/artificial intelligence (AI) model involves teaching the model to perform specific tasks by exposing the model to large datasets and iteratively adjusting the model's parameters to minimize errors. During training, the model processes input data, makes predictions, and/or compares those predictions to the actual outcomes using, for example, a loss function. Based on the loss, an optimization algorithm (e.g., a gradient descent algorithm) updates the model's parameters to improve the model's accuracy. This process is computationally intensive, particularly for deep learning models with millions or billions of parameters, and may take days or even weeks to complete, depending on the size and complexity of the model and datasets.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of a server in accordance with one or more embodiments disclosed herein.

FIG. 1.3 shows a diagram of a server rack in accordance with one or more embodiments disclosed herein.

FIG. 1.4 shows a diagram of a system in accordance with one or more embodiments disclosed herein.

FIG. 2.1-2.3 show a method for managing data in accordance with one or more embodiments disclosed herein,

FIG. 3 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, AI workloads/jobs require large volumes of data to be moved from persistent storage to retrieve previously checkpointed models, to read dataset batches used for training (and/or fine-tuning) models, and to load pre-trained models for inferencing, for example, images, in which persistent storage volumes may be local (e.g., reside on the same node/server as the related graphics processing unit (GPU)) or may be remote (e.g., reside on an external storage device) and accessed over a network.

GPUs used for AI workloads are usually expensive, deployed in large numbers, and consume a significant amount of electricity that should be dissipated in the form of heat. These expenditures continue even when a corresponding GPU is not formally processing data. To ensure the best possible return on investment (ROI) and to limit wasted operating expenditures associated with idle GPUs, one should ensure that GPUs spend as little time as possible waiting for training and/or inferencing data to be loaded,

As used herein, the term “AI workloads” may refer to training (pre-training or fine-tuning) models or inferencing data, in which AI workloads may have diverse requirements for data retrieval. For example, for retrieval of training data, data retrieval may be executed in parallel with model training iterations, and data batches may be prepositioned in memory of (i) a data processing unit (DPU) or (ii) a Top-of-Rack (ToR) switch, to avoid lengthy delays in providing data to relevant GPUs. As yet another example, for loading of model checkpoints (e.g., Large Language Model (LLM) checkpoints) from a storage device, the amount of data per GPU may be 40 gigabytes (GB) or more (depending on the GPU type,

AI model, model parallelism, etc.). Some AI models are large and are trained on thousands of GPUs. The failure of a single GPU (of those GPUs), or the need to restart training from partway through a previous exercise may require all the GPUs to be reloaded from the previous checkpoint. For LLMs, the order of magnitude can reach terabytes of data (e.g., 1024×40 GB=40 terabytes (TB)) and, as the GPUs are idle while the data is transferred, the transfer duration should be as short as possible.

Further, in most cases, the storage data retrieval rate (e.g., a typical rate is 5 GB per second (GB/s)) is significantly slower than the network bitrate (e.g., 400 Gigabits per second (Gbps) Ethernet=50 GB/s). At this rate, the storage input/output (I/O) read bandwidth (BW) may become a bottleneck, in which at least 8 seconds (40 GB/5 GB/s) may be required to retrieve a checkpoint for each GPU. In addition, if the same storage device stores the checkpointed model data for multiple GPUs, the total duration can be orders of magnitude higher.

As yet another example, AI inference workloads may include (i) loading of AI models when initiating AI workloads and (ii) retrieval of data batches/queries for inferencing (which applies to situations where relatively large volumes of data (e.g., medical images) are stored and retrieved for inferencing). Separately, while the quantity of data used during inferencing is less than that is required for model training, latency in generating results becomes more important (for this reason, time wasted while data is moved into or out of a related GPU is often significant).

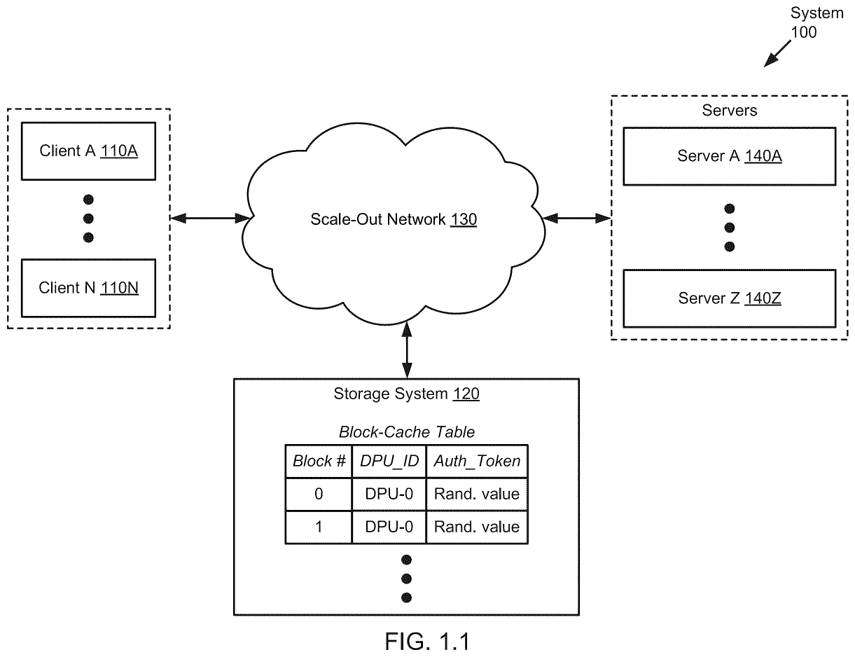

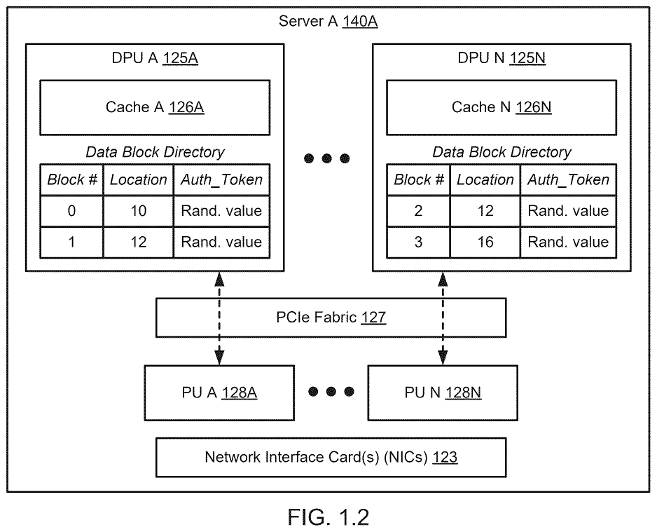

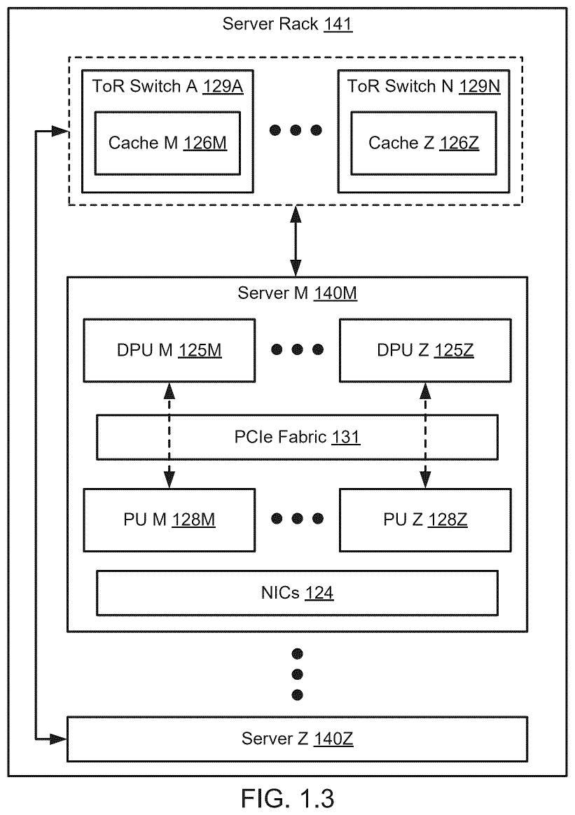

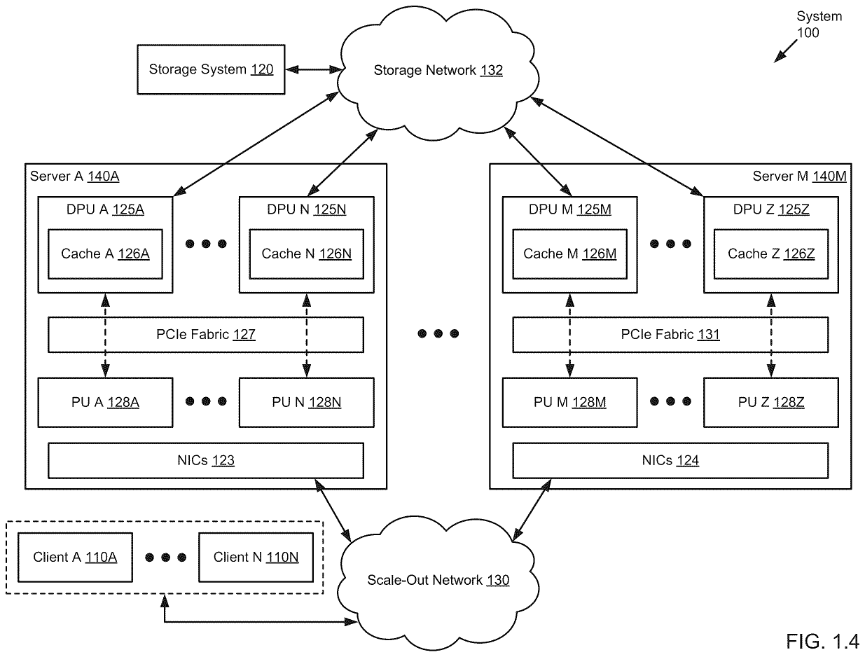

From a different perspective, GPUs typically load training or inferencing data into their memory from an external storage array/system. However, many storage arrays have a limited number of connections to a corresponding storage network (see FIG. 1.4), limiting the rate at which data can be loaded, particularly for server clusters with a significant number of GPUs.

In addition, the rate at which the storage system can deliver the requested data may be further limited by the read speed of the backing storage in the storage system. Traditional caching techniques (employed by the storage system) are unlikely to be of significant value as the amount of memory resulting from a large number of GPUs is significantly larger than the storage space in the storage system to cache data.

From the underlying storage perspective, the aforementioned issue may mean that the data should be prepared in a pipeline of transformations and delivered in advance to cache local to each GPU (e.g., cache that is not part of the storage system). This ensures that the data can be rapidly transferred to the GPUs on demand over an exclusive, high-speed and uncongested communications path (typically, over a peripheral component interconnect express (PCIe) bus).

For at least the reasons discussed above and without requiring resource-intensive efforts (e.g., time, engineering, etc.), a fundamentally different solution/framework is needed (e.g., a framework that leverages DPUs, a storage (or a storage system), and/or a scale-out network to optimize data retrieval from both local and remote storage using a deduped read-ahead approach, leveraging identification of duplicated data by the storage system).

Embodiments disclosed herein relate to methods and systems to manage data to perform various AI workloads/operations. As a result of the processes discussed below, one or more embodiments disclosed herein advantageously ensure that: (i) the framework generates distributed, deduplicated cache for, at least, AI model training or inferencing to manage/use static (or, eventually, coherent data); (ii) the framework effectively use a high-BW network fabric (e.g., a scale-out network) to reduce the volume of I/O operations from/to a related storage system; and/or (iii) the framework enables a mechanism by which DPUs with expanded memory (see FIG. 1.4), connected to a storage network/fabric, can provide high-speed distributed cache (where each DPU may have a dedicated connection to the storage network, which may result in a significantly higher BW between pairs of DPUs than exists between all the DPUs and the storage system).

The following describes various embodiments disclosed herein.

While the following describes using caches (or storage) in DPUs and/or ToR switches, embodiments disclosed herein may be implemented using other caches that are operatively connected to the processing units (e.g., GPUs, Neural Processing Units (NPUs), Tensor Processing Units (TPUs), central processing units (CPUs), etc.) without departing from the scope of the embodiments disclosed herein. Further, while the following describes embodiments in the context of AI workloads, embodiments disclosed herein may be implemented for any other types of workloads without departing from the scope of the embodiments disclosed herein.

FIG. 1.1 shows a diagram of a system (100) in accordance with one or more embodiments disclosed herein. The system (100) includes any number of clients (e.g., Client A (110A), Client N (110N), etc.), a storage system/array (120), any number of servers/nodes (e.g., Server A (140A), Server Z (140Z), etc.), and a scale-out network/fabric (130). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the clients (e.g., 110A, 110N, etc.), the storage system (120), the servers (e.g., 140A, 140Z, etc.), and the scale-out network (130) may be (or may include) physical hardware or logical devices, as discussed below. While FIG. 1.1 shows a specific configuration of the system (100), other configurations may be used without departing from the scope of the embodiments disclosed herein (see FIG. 1.4). For example, although the clients (e.g., 110A, 110N, etc.) and the servers (e.g., 140A, 140Z, etc.) are shown to be operatively connected through a communication network (enabled by the scale-out network (130)), the clients (e.g., 110A, 110N, etc.) and the servers (e.g., 140A, 140Z, etc.) may be directly connected (e.g., without an intervening communication network).

Further, the functioning of the clients (e.g., 110A, 110N, etc.) and the servers (e.g., 140A, 140Z, etc.) is not dependent upon the functioning and/or existence of the other components (e.g., devices) in the system (100). Rather, the clients and the servers may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, a “volume” may be analogous to a logical unit number in a storage area network (SAN), in which a volume may be a subset of the storage system's (120) capacity presented by a storage node of the storage as a local block device. A volume's data may be evenly distributed across all storage resources of the storage system (120), for example, according to a data layout selected for the storage system (120).

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

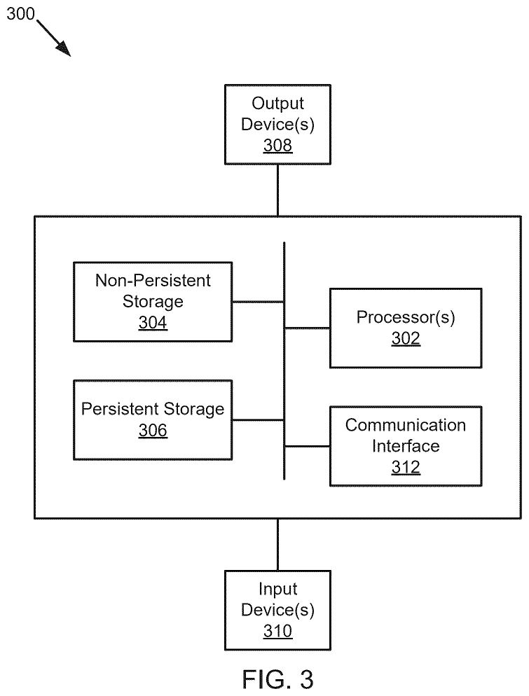

In one or more embodiments, the system (100) may be a distributed system (e.g., a data processing environment) and may deliver at least computing power (e.g., real-time (on the order of milliseconds (ms) or less) network monitoring, server virtualization, data deduplication, etc.), storage capacity (e.g., data backup), and data protection (e.g., software-defined data protection, disaster recovery, etc.) as a service to users (e.g., people, tenants, etc.) of clients (e.g., 110A, 110N, etc.). For example, the system (100) may be configured to organize unbounded, continuously generated data into a data stream. The system (100) may also represent a comprehensive middleware layer executing on computing devices (e.g., 300, FIG. 3) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the clients (e.g., 110A, 110N, etc.)) and other computations remotely (e.g., away from the users' site using the servers (e.g., 140A, 140Z, etc.)) from the users. By doing so, the users may utilize different computing devices (e.g., 300, FIG. 3) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., Server A (140A), the storage system (120), etc.), store, or otherwise utilize captured sensor data (and/or any other type and/or quantity of data), (iv) provide surveillance services (e.g., determining object-level information, performing face recognition, etc.) for scenes (e.g., a physical region of space), (v) initiate AI/ML model training and/or AI inferencing applications on one or more servers (e.g., 140A, 140Z, etc.), and/or (vi) monitor the status of the AI model training and/or receive the results of AI inferencing applications. One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the servers (e.g., 140A, 140Z, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the servers (e.g., 140A, 140Z, etc.) and/or the storage system (120). For example, the clients may issue requests to Server A (140A) to receive responses and interact with various components of Server A (140A). The clients may also request data from and/or send data to Server A (140A) (for example, the clients may transmit information to Server A that allows Server A to perform computations, the results of which are used by the clients to provide services to the users). As yet another example, the clients may utilize computer-implemented services provided by Server Z (140Z). When the clients interact with Server Z (140Z), data that is relevant to the clients may be stored (temporarily or permanently) in Server Z.

In one or more embodiments, a client (e.g., 110A, 110N, etc.) may be capable of, e.g.,: (i) collecting users' inputs, (ii) correlating collected users'inputs to the computer-implemented services to be provided to the users, (iii) communicating with the servers (e.g., 140A, 140Z, etc.) and/or the storage system (120) that perform computations necessary to provide the computer-implemented services, (iv) using the computations performed by, for example, Server A (140A) to provide the computer-implemented services in a manner that appears (to the users) to be performed locally to the users, and/or (v) communicating with any virtual desktop (VD) in a virtual desktop infrastructure (VDI) environment (or a virtualized architecture) provided by the servers (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a CPU, a GPU, a DPU, a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., Server A (140A), the storage system (120), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), RDMA, RDMA over Converged Ethernet (RoCE), IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing Remote DMA (“RDMA”), e.g., RoCE to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 GB of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 300, FIG. 3). The computing device may be, for example, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 300, FIG. 3) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, a server of the servers (e.g., 140A, 140Z, etc.) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the storage for management of the data and/or for storage of the data (while pushing the data, the server may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML/AI models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another server for review and/or other human interactions; (x) exchange data with other devices registered in/to the scale-out network (130) in order to, for example, participate in a collaborative workload placement (e.g., the node may split up a request (e.g., an operation, a task, an activity, etc.) with another server, coordinating its efforts to complete the request more efficiently than if the server had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the storage system (120); (xv) provide (e.g., via a broadcast, multicast, or unicast mechanism) information (e.g., a location identifier, the amount of available resources, etc.) associated with the server to other servers of the system (100); (xvi) configure or control any mechanism that defines when, how, and what data to provide to the clients and/or to the storage system; (xvii) provide data deduplication to the clients (in conjunction with the storage system (120)); (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., a server may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the server (e.g., 140A, 140Z, etc.) may communicate with, for example, the storage system (120) and/or other storage devices in the system (100).

Further, a server of the servers (e.g., 140A, 140Z, etc.) may include functionality to execute one or more AI workloads (e.g., AI (or AI model) training workloads, AI inferencing workloads, etc.). Each server may include a local AI application (not shown) that manages the execution of various AI workloads on, for example, processing units (e.g., GPUs, NPUs, TPUs, CPUs, etc.) and/or DPUs of that server (see e.g., FIG. 1.2-1.4). In one or more embodiments, the servers (e.g., 140A, 140Z, etc.) may be operatively connected to each other via a ToR switch when the servers are in the same server rack (see e.g., FIG. 1.3), or via the scale-out network (130) when the servers are in different server racks and/or in different geographic locations/zones across the world.

As described above, a server (e.g., 140A, 140Z, etc.) may be capable of providing a range of functionalities/services to the users of the clients (e.g., 110A, 110N, etc.). However, not all users may be allowed to receive all the services. To manage the services provided to the users of the clients, a service manager (not shown) in accordance with embodiments disclosed herein may manage the operation of the scale-out network (130), in which the clients are operably connected to the servers over the scale-out network. Specifically, the service manager (i) may identify services to be provided by the servers (for example, based on the number of users using the clients) and (ii) may limit communications of the clients to receive server provided services.

For example, the priority (e.g., the user access level) of a user may be used to determine how to manage computing resources of Server A (140A) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g. a non-privileged user, a user with a user access level/tier of 4/10). In such a scenario, the user level of that user may indicate that certain ports (of the subcomponents of the network corresponding to communication protocols such as the TCP, the UDP, etc.) are to be opened, other ports are to be blocked/disabled so that (i) certain services are to be provided to the user by Server Z (140Z) (e.g., while the computing resources of Server Z may be capable of providing/performing any number of remote computer-implemented services, they may be limited in providing some of the services over the network enabled/provided by the scale-out network (130)) and (ii) network traffic from that user is to be afforded a normal level of quality (e.g., a normal processing rate with a limited communication BW). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) Server A (140A) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): an AI workload, a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of an SLA (or a rule) that applies to source data, identity of a target device where source data is to be stored, etc.

As used herein, the term “backup” is intended to be broad in scope. In this manner, example backups (in connection with which embodiments disclosed herein) may be employed include (but not limited to): full backups, partial backups, clones, snapshots, incremental backups, differential backups, etc.

As used herein, “data retention” is a period of time, with a definite start and end, within which the data should be retained in storage/database (e.g., 120). For example, a set of user requirements and/or technical considerations (e.g., security considerations, performance considerations, etc.) of a data center may be used to generate a data retention policy specifying that user data should be retained in the database for seven years.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

Further, while a single server (e.g., 140A) is considered above, the term “server” includes any collection of systems or sub-systems that individually or jointly execute a set, or multiple sets, of instructions to provide one or more computer-implemented services. For example, a single server may provide a computer-implemented service on its own (i.e., independently) while other servers may provide a second computer-implemented service cooperatively (e.g., each of the other servers may provide similar or different services that form the cooperatively provided service).

As described above, a server (e.g., 140A) may provide any quantity and any type of computer-implemented services. To provide computer-implemented services, the server may be a heterogeneous set, including a collection of physical components/resources (discussed above) configured to perform operations of the server and/or otherwise execute a collection of logical components/resources (discussed above) of the server.

In one or more embodiments, a server (e.g., 140A, 140Z, etc.) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

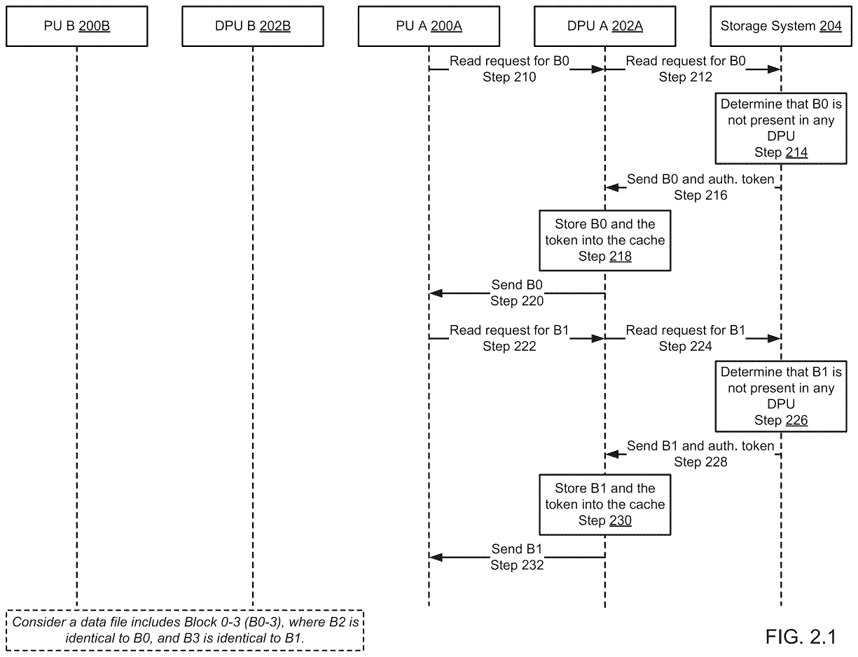

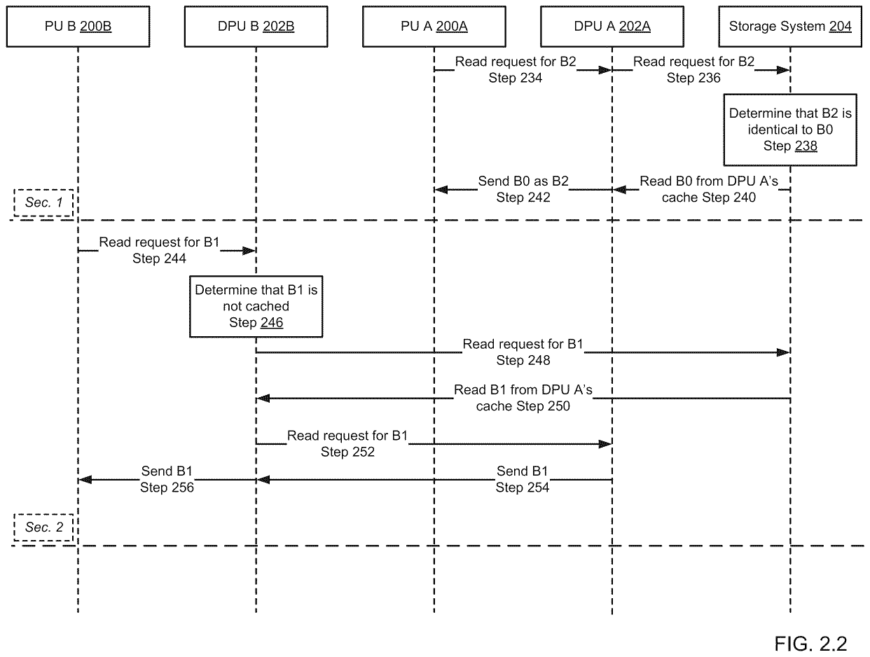

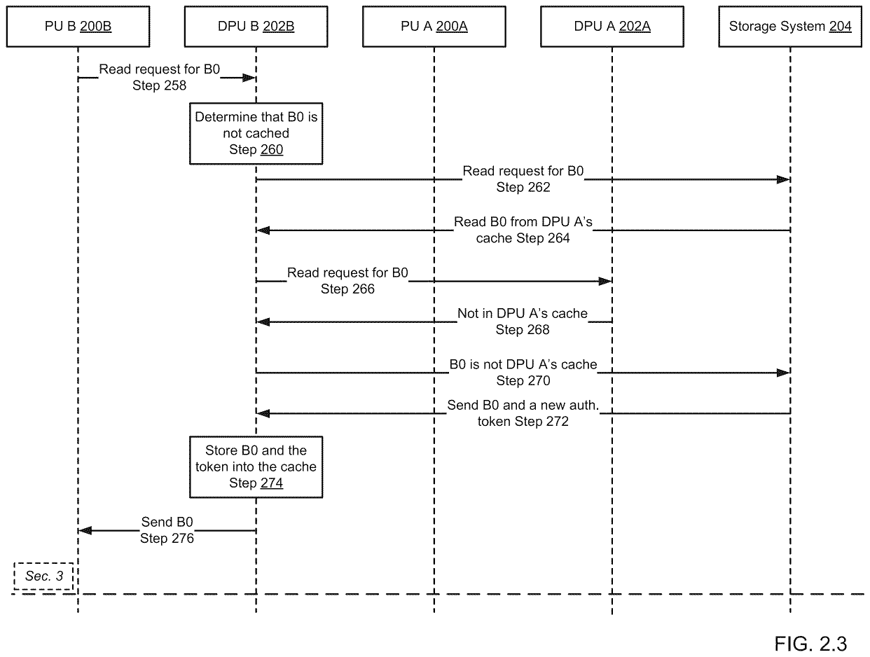

One of ordinary skill will appreciate that a server (e.g., 140A, 140Z, etc.) may perform other functionalities without departing from the scope of the embodiments disclosed herein. In one or more embodiments, a server (e.g., 140A, 140Z, etc.) may be configured to perform all, or a portion, of the functionalities described in FIG. 2.1-2.3.

In one or more embodiments, a server (e.g., 140A, 140Z, etc.) may be implemented as a computing device (e.g., 300, FIG. 3). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the server described throughout the application.

Alternatively, in one or more embodiments, similar to a client (e.g., 110A, 110N, etc.), the server may also be implemented as a logical device.

In the embodiments of the present disclosure, the storage system (120) is demonstrated as a separate entity from a server (e.g., 140A, 140Z, etc.); however, embodiments disclosed herein are not limited as such. The storage system (120) may be demonstrated as a part of a server (e.g., as deployed to the server).

Turning now to the storage system (120), the storage system (120) may provide long-term, durable, high read/write throughput data storage/protection with near-infinite scale and low-cost. The storage system (120) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. For example, the storage system (120) may store data (e.g., backup data; file system metadata; assets; rules and/or procedures for performing backups of the servers; etc.). Further, the storage system (120) may also occupy a portion of a physical storage/memory device or, alternatively, may span across multiple physical storage/memory devices. The storage system (120) may include other and/or additional functionalities without departing from embodiments disclosed herein.

In one or more embodiments, the storage system (120) may be implemented using physical devices that provide data storage services (e.g., storing data and providing copies of previously stored data). The devices that provide data storage services may include hardware devices and/or logical devices. For example, the storage system (120) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage system (120) may include a memory device (e.g., a dual in-line memory device), in which data is stored and from which copies of previously stored data are provided. As yet another example, the storage system (120) may include a persistent storage device (e.g., an SSD), in which data is stored and from which copies of previously stored data is provided. As yet another example, the storage system (120) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the storage system (120) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the storage system (120) may store/log/record unstructured and/or structured data that may include (or specify), for example (but not limited to): a backup policy/practice; telemetry data including past and present device usage of one or more computing devices; data for execution of applications/services including server applications and associated end-points; corpuses of annotated data used to build/generate and train processing classifiers for trained AI models; linear, non-linear, and/or AI model parameters; data tags; an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; an identifier of a user (e.g., a unique string or combination of bits associated with a particular user) who initiated a backup (via a client); a distributed model identifier that uniquely identifies a distributed model; a user activity performed on a data item; a cumulative history of user/administrator activity records obtained over a prolonged period of time; a setting (and a version) of a mission critical application executing on a server (e.g., 140A); configuration information associated with a server (e.g., 140A); a job detail of a job that has been initiated by a server (e.g., 140A); a type of the job (e.g., a non-parallel processing job, a parallel processing job, an analytics job, etc.); information associated with a hardware resource set (discussed below) of a server (e.g., 140A); a completion timestamp encoding a date and/or time reflective of the successful completion of a job; a time duration reflecting the length of time expended for executing and completing a job; a backup retention period associated with an asset (e.g., data item); a status of a job (e.g., how many jobs are still active, how many jobs are completed, etc.); a number of requests handled (in parallel) per minute (or per second, per hour, etc.) by a server (e.g., 140A); a number of errors encountered when handling a job (e.g., a backup process); a documentation that shows how a server (e.g., 140A) performs against an SLO and/or an SLA; a set of requests received by a server (e.g., 140A); a set of responses provided (by the server) to those requests; information regarding an administrator (e.g., a high-priority trusted administrator, a low-priority trusted administrator, etc.) related to a job; tier/level information of a user (e.g., a high-privileged user, a low-privileged user, etc.); a geographic location (e.g., a country) associated with the user; a timestamp showing when a specific request is processed by a server (e.g., 140A); computing resource details (including details of hardware components and/or software components) and an IP address of a server (e.g., 140A) hosting an application where a specific request is processed; information with respect to historical metadata (e.g., system logs, applications logs, telemetry data including past and present device usage of one or more computing devices in the system (100), etc.); computing resource details and an IP address of a client that sent a specific request (e.g., to a server); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; checkpoint data; data used for AI model training and/or AI inferencing; etc.

In one or more embodiments, information associated with a hardware resource set (e.g., including at least resource related parameters) may specify, for example (but not limited to): a configurable CPU option (e.g., a valid/legitimate vCPU count for a server (e.g., 140A)), a configurable network resource option (e.g., enabling/disabling single-root input/output virtualization (SR-IOV) for the server), a configurable memory option (e.g., maximum and minimum memory for the server), a configurable GPU option (e.g., allowable scheduling policy and/or virtual GPU (vGPU) count combinations for the server), a configurable DPU option (e.g., legitimacy of disabling inter-integrated circuit (I2C) for the server), a configurable storage space option (e.g., a list of disk cloning technologies across one or more servers in the system (100)), a configurable storage I/O option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per server in the system (100), a wake on LAN support configuration (e.g., supported/enabled, not supported/disabled, etc.), a vGPU count per server in the system (100), a type of a vGPU scheduling policy (e.g., a “fixed share” vGPU scheduling policy), a storage mode configuration (e.g., an enabled high-performance storage array mode), etc.

While the storage system (120) has been illustrated and described as including a limited number and type of data, the storage system (120) may store additional, less, and/or different data without departing from the scope of the embodiments disclosed herein. One of ordinary skill will appreciate that the storage system (120) may perform other functionalities without departing from the scope of the embodiments disclosed herein.

In one or more embodiments, the storage system (120) may be configured to perform all, or a portion, of the functionalities described in FIG. 2.1-2.3.

In one or more embodiments, AI model training involves multiple processes/steps. Two such processes that have an impact on the performance of AI model training are checkpointing and loading of “training” data into processing units (e.g., GPUs, DPUs, NPUs, TPUs, CPUs, etc.). Checkpointing refers to the process of saving the intermediate states or parameters (also referred to as checkpoint data) of an AI model during training at regular intervals. This allows the training process to be paused and resumed from a saved point without having to start over, ensuring that progress is not lost due to interruptions, for example, due to computing resource failures, time limits, or other constraints. Checkpointing is a crucial aspect of training large and complex AI models, particularly in deep learning, where training can take a long time and involve extremely large datasets.

Further, the amount of time that a given processing unit is paused is directly related to the amount of time required to transmit the checkpoint data from the unit to persistent storage, where the persistent storage (e.g., of the storage system) may be located outside of a related server (e.g., 140A) on which the unit is executing. The amount of time required is most significantly affected (or impacted) by latency in the network path (which may include multiple hops) between the server and the storage. Any decrease in the amount of time a processing unit is paused during the checkpointing process may improve the utilization of the unit and, as a result, decrease the amount of time required to, for example, train an AI model and decrease the amount of computing resources expended to train the AI model.

In one or more embodiments, the storage system (120) may include/maintain a table (e.g., a “block-cache table”) for each file. Each data (e.g., Block 0, Block 1, etc.) in the block-cache table may have one record (e.g., each data block in the table may be represented with a single record), and each record may include the following two fields: (i) DPU_ID: This field may include (a) the identifier (ID) of a DPU (e.g., a VXLAN/IP address tuple associated with the DPU, a Domain Name System (DNS) identifier of the DPU, etc.) to which the storage system (120) last sent a corresponding data block or (b) zero (0) if the data block has never been sent to any DPU; and (ii) Auth_Token: This field may include a randomly-generated authorization token (Auth_Token, which is a large random value) for a data block to be used to ensure only authorized DPUs can access a cached data block in a related DPU's cache.

While the block-cache table has been illustrated and described as including a limited number and type of data, the block-cache table may store additional, less, and/or different data without departing from the scope of the embodiments disclosed herein. Additional details of an authorization token is described below in reference to FIG. 2.1-2.3.

In one or more embodiments, all, or a portion, of the components of the system (100) may be operably connected each other and/or other entities via any combination of wired and/or wireless connections. For example, the aforementioned components may be operably connected, at least in part, via a network (e.g., the scale-out network (130) or any other network topology). Further, all, or a portion, of the components of the system (100) may interact with one another using any combination of wired and/or wireless communication protocols.

In one or more embodiments, the scale-out network (130) may be a distributed networking architecture designed to handle increases in data traffic and workloads by adding more resources (e.g., servers, network devices, etc.). The components of the scale-out network (130) may be connected via a network fabric (not shown). As used herein, a network fabric may refer to the interconnected topology and structure of network components/devices (e.g., switches, routers, links, etc.) in the scale-out network that operate together to provide high-speed, low-latency data transmission across the system (100).

In one or more embodiments, the network/communication fabric may be implemented using a spine-leaf topology, in which every leaf network device connects to each spine network device. Each component of the system (100) may directly connect to the leaf network devices via one or more ToR switches. Those skilled in the art will appreciate that while FIG. 1.1 and 1.4 indicate a scale out network, any other type of network (or network topology) may be used without departing from the scope of the embodiments disclosed herein.

In one or more embodiments, the scale-out network (130) may represent a (decentralized or distributed) computing network and/or fabric configured for computing resource and/or messages exchange among registered computing devices (e.g., the clients, the servers, the storage, etc.). As discussed above, components of the system (100) may operatively connect to one another through the network (e.g., a SAN, a personal area network (PAN), a LAN, a metropolitan area network (MAN), a WAN, a mobile network, a wireless LAN (WLAN), a virtual private network (VPN), an intranet, the Internet, etc.) enabled by the network fabric, which facilitates the communication of signals, data, and/or messages. In one or more embodiments, the scale-out network (130) may be implemented using any combination of wired and/or wireless network topologies, and the network may be operably connected to the Internet or other networks. Further, the network may enable interactions between, for example, the clients and the servers through any number and type of wired and/or wireless network protocols (e.g., TCP, UDP, IPv4, etc.).

As discussed above, the scale-out network (130) may encompass various interconnected, network-enabled subcomponents (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The subcomponents (e.g., network devices) may be implemented using hardware, software, or any combination thereof.

In one or more embodiments, before communicating data over the scale-out network (130), the data may first be broken into smaller batches (e.g., data packets, data blocks, etc.) so that larger size data can be communicated efficiently. For this reason, the network-enabled subcomponents may break data into data packets. The network-enabled subcomponents may then route each data packet in the scale-out network (130) to distribute network traffic uniformly.

In one or more embodiments, the network-enabled subcomponents may decide how real-time network traffic and non-real-time network traffic should be managed in the scale-out network (130). In one or more embodiments, the real-time network traffic may be high-priority (e.g., urgent, immediate, etc.) network traffic. For this reason, data packets of the real-time network traffic may need to be prioritized in the scale-out network (130). The real-time network traffic may include data packets related to, for example (but not limited to): videoconferencing, web browsing, voice over Internet Protocol (VoIP), etc.

While FIG. 1.1 shows a configuration of components, other system configurations may be used without departing from the scope of the embodiments disclosed herein.

Turning now to FIG. 1.2, FIG. 1.2 shows a diagram of a server (e.g., Server A (140A)) in accordance with one or more embodiments disclosed herein. More specifically, FIG. 1.2 shows additional details about a server in accordance with one or more embodiments disclosed herein. As being a physical computing device, the server (140A) includes a set of DPUs (e.g., DPU A (125A), DPU N (125N), etc.) operatively connected to a set of processing units (PUs) (e.g., PU A (128A), PU N (128N), etc.) (in which the set of PUs may include any types of PUs such as GPUs, NPUs, TPUs, CPUs, etc.) via a PCIe fabric (127), and a set of NICs (123) (e.g., to execute multiple AI workloads that use same network connections on the scale-out network (e.g., 130, FIG. 1.1)). The server (140A) may include additional, fewer, and/or different components without departing from the scope of the embodiments disclosed herein. Each component may be operably connected to any of the other components via any combination of wired and/or wireless connections. Each component illustrated in FIG. 1.2 is discussed below.

In one or more embodiments, the server (140A) may communicate with, transmit data to, and/or receive data from other servers (e.g., 140Z, FIG. 1.1) and the storage system (e.g., 120, FIG. 1.1) via the scale out network (e.g., 130, FIG. 1.1).

In one or more embodiments, the PCIe fabric (127) is a high-speed, point-to-point interconnect architecture that allows the set of PUs (e.g., 128A, 128N, etc.) and the set of DPUs (e.g., 125A, 125N, etc.) (as well as other hardware components (not shown) in the server) to communicate directly with each other using the PCIe protocol and one or more PCIe switches.

Further, the set of DPUs (e.g., 125A, 125N, etc.) and the set of PUs (e.g., 128A, 128N, etc.) may communicate and/or transmit data to each other via the PCIe fabric (127) using PCIe interfaces located on each DPU and PU. Some embodiments may include PCIe switches between the DPUs/NICs and PUs. In another embodiment, a Compute Express Link (CXL) bus, or other interconnect technologies, may be used to connect a PU (e.g., a GPU, an NPU, a TPU, etc.) and associated DPU(s). In one or more embodiments, the server (140A) may also include other hardware components/resources such as, for example, processors, volatile storage (e.g., memory), non-volatile storage (e.g., HDDs, SSDs, etc.), etc.

As used herein, a GPU (e.g., 128A, 128N, etc.) is a specialized electronic component that includes multiple cores (also referred to as GPU cores) arranged to enable high-performance parallel computing tasks. A GPU also includes large amounts of volatile memory (e.g., memory sufficient to store 80 GB of data) to support the parallel processing of the multiple GPU cores. For AI model training and AI inferencing, a GPU (e.g., 128A, 128N, etc.) may provide/implement additional functionalities without departing from the scope of the embodiments disclosed herein.

As used herein, a DPU (e.g., 125A, 125N, etc.) is a specialized electronic component that includes one or more network interfaces and is designed to offload various networking tasks (e.g., packet processing, encryption, data compression, network virtualization, etc.) from the server's CPU (not shown). A DPU (e.g., 125A, 125N, etc.) may include local volatile storage (e.g., a DPU with expanded memory) in the form of a cache (e.g., Cache A (126A), Cache N (126N), etc.). Those skilled in the art will appreciate that (i) the cache may be implemented using any other form of volatile and/or non-volatile storage (e.g., RAM, Flash memory, magnetic memory, etc.) and/or (ii) may be located in a GPU or a ToR switch (e.g., 129A, FIG. 1.3) without departing from the scope of the embodiments disclosed herein.

Further, in the server (140A), each of the DPUs (e.g., 125A, 125N, etc.) may be mapped 1:1 to a PU (e.g., 128A, 128N, etc.). For example, PU A (128A) may be mapped to DPU A (125A). Once mapped, the cache (e.g., 126A) of DPU A (125A) may be used to store checkpoint data from PU A (128A) as well as data that is to be used by PU A (128A) for AI model training and/or AI inferencing. A DPU (e.g., 125A, 125N, etc.) may provide additional functionalities without departing from the scope of the embodiments disclosed herein.

As discussed above, each of the DPUs in the server (140A) may include cache (e.g. 126A, 126N, etc.). This cache (e.g., one or more memory regions) may be sized such that the cache can temporarily store checkpoint data (or data blocks) that are (i) generated by a corresponding PU(s) in the server (140A) or (ii) obtained from the storage system (e.g., 120, FIG. 1.1). In this manner, a PU (e.g., 128A, 128N, etc.) may only be paused for the time the PU takes to obtain the checkpoint data and then transmit the checkpoint data to a related DPU (which may be mapped 1:1 or 1:N to the PU) via the PCIe fabric (127). Once the checkpoint data has been stored in the cache, the PU can resume execution of, for example, the AI workload. By locally storing the checkpoint data in the cache, the PU can resume operation prior the checkpoint data being stored in, for example, the storage system (e.g., 120, FIG. 1.1).

Further, each DPU (e.g., 125A, 125N, etc.) may include a data block directory for each open file (e.g., a file that is opened/accessed by a relevant DPU in the storage system (e.g., 120, FIG. 1.1)), in which the directory may include the following fields: (i) Block #: This field may include a number/identifier of a data block; (ii) Location: This field may include (a) a location (or location information) of the data block in the DPU's cache or (b) or zero (0) if the data block is not cached; and (iii) Auth_Token: This field may include a randomly-generated authorization token (Auth_Token) for the data block.

In one or more embodiments, the data block may be (i) part of training data (or fine-tuning data) that a related PU needs to use while training an AI model or (ii) part of inferencing data that the related PU needs to analyze.

In one or more embodiments, a NIC of the NICs (123) may implement and/or support one or more protocols to enable the communication between the server (140A) with one or more other devices (e.g., other servers in the system, one or more clients, etc.). For example, the NIC may enable the server (140A) to be operatively connected, via Ethernet, using a TCP/IP protocol to form a “network fabric” and enable the communication of data between the server (140A) and other external entities. In one or more embodiments, each server within the system (e.g., 100, FIG. 1.1) may be given a unique identifier (e.g., an IP address) to be used when utilizing one or more protocols.

One of ordinary skill will appreciate that a NIC of the NICs (123) may perform other functionalities (e.g., being used by a PU (e.g., 128A) and/or a DPU (e.g., 125A) of the server (140A)) without departing from the scope of the embodiments disclosed herein. The NIC may be implemented as a computing device using hardware (e.g., any number of integrated circuits for processing computer readable instructions), software (e.g., a computer program), or any combination thereof.

In one or more embodiments, the set of DPUs (e.g., 125A, 125N, etc.), the set of PUs (e.g., 128A, 128N, etc.), the PCIe fabric (127), and the set of NICs (123) may be utilized in isolation and/or in combination to provide the aforementioned functionalities. These functionalities may be invoked using any communication model including, for example, message passing, state sharing, memory sharing, etc.

In one or more embodiments, instead of staging data (e.g., checkpoint data) with caches (e.g., Cache A (126A), Cache N (126N), etc.) in a server (e.g., Server A (140A)), the data may be staged in the cache (or memory) of one or more ToR switches in a related server rack, in which a server hosting one or more PUs is located. Accordingly, instead of caching the data at the DPU level or server level (e.g., FIG. 1.2), the data may be cached at the server rack level. While transmission of the data to a ToR switch may require two hops (e.g., PU→DPU (or NIC)→ToR switch), the effective bit rate for these two hops is typically substantially higher than the bit rate (e.g., I/O storage rate) of the storage system (e.g., 120, FIG. 1.1).

Turning now to FIG. 1.3, FIG. 1.3 shows a diagram of a server rack (141) in accordance with one or more embodiments disclosed herein. In one or more embodiments, the server rack (141) may be a chassis (e.g., a mechanical structure) configured to house (or otherwise locate) one or more servers/blades (e.g., Server M (140M), Server Z (140Z), etc.) and their components. The servers (e.g., 140M, 140Z, etc.) in the server rack (141) may be directly connected to the one or more ToR switches (e.g., ToR Switch A (129A), ToR Switch N (129N), etc.).

In one or more embodiments, the ToR switches (e.g., 129A, 129N, etc.) may facilitate inter-server communications for servers within the server rack (141) as well as communication between the servers in the server rack (141) and external components (e.g., other servers in other server racks, the scale-out network (e.g., 130, FIG. 1.1), etc.).

Referring to FIG. 1.3, the PUs (e.g., 128M, 128Z, etc.) (in which the PUs may include any types of PUs such as GPUs, NPUs, TPUs, CPUs, etc.) may send data (e.g., checkpoint data) to the ToR switches (e.g., 129A, 129N, etc.) via the corresponding DPUs (e.g., 125M, 125Z, etc.). Said another way, the DPUs in the servers (e.g., 140M, 140Z, etc.) may facilitate the transfer of the data but may not cache the data. As a result, the DPUs may not need to include large local caches (as compared to the embodiment shown in FIG. 1.2); rather, the ToR switches (e.g., 129A, 129N, etc.) may need to include larger caches.

Referring to FIG. 1.3, FIG. 1.3 shows additional details of a server (e.g., 140M, 140Z, etc.) in the server rack (141). Similar to FIG. 1.2, a server may include any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, as being a physical computing device, Server M (140M) includes a set of DPUs (e.g., DPU M (125M), DPU Z (125Z), etc.) operatively connected to a set of PUs (e.g., PU M (128M), PU Z (128Z), etc.) via a PCIe fabric (131), and a set of NICs (124) (e.g., to execute multiple AI workloads that use same network connections on the scale-out network (e.g., 130, FIG. 1.1)). The set of DPUs and PUs may be mapped 1:1 or 1:N depending on the implementation of embodiments disclosed herein. Server M (140M) may include additional, fewer, and/or different components without departing from the scope of the embodiments disclosed herein. Each component may be operably connected to any of the other components via any combination of wired and/or wireless connections. In one or more embodiments, the components of Server M (140M) may have the same or substantially the same functionality as the liked named components in FIG. 1.2. Separately, compared to Server M (140M), Server Z (140Z) may have/perform additional, fewer, and/or different components/functionalities without departing from the scope of the embodiments disclosed herein.

Continuing with the discussion of FIG. 1.3, each of the ToR switches (e.g., 129A, 129N, etc.) may include local cache (e.g., Cache M (126M), Cache Z (126Z), etc.) that is used to store data (e.g., checkpoint data, the data for AI model training and/or AI inferencing). The size of the cache in a given ToR switch may be based on how much data (which may or may not be compressed) is to be stored in/to the cache. Further, unlike the caches in the DPUs (described above in reference to FIG. 1.2), the cache in a given ToR switch may store data that are located in different servers (e.g., 140M, 140Z, etc.) in the server rack (141).

Turning now to FIG. 1.4, FIG. 1.4 shows a diagram of the system (100) in accordance with one or more embodiments disclosed herein. The components shown in FIG. 1.4 may have the same or substantially the same functionality as the liked components in FIG. 1.1-1.2. However, referring to FIG. 1.1, the scale-out network (130) may handle all communication traffic among the components of the system (100). Accordingly, the scale-out network (130) may handle both storage traffic (i.e., network traffic between the storage system (120) and the servers (e.g., 140A, 140Z, etc.)) as well as all other non-storage traffic (e.g., communication traffic among the servers).

Further, in the system (100) demonstrated in FIG. 1.1, DPUs (e.g., 125A, 125N, FIG. 1.2) of the servers may include functionality to prioritize the transmission of non-storage traffic over the storage traffic. For example, if a PU (e.g., 128A, FIG. 1.2) of the server is attempting to send non-storage traffic to a PU (referred to as a target PU (not shown)) in another server (e.g., 140Z, FIG. 1.1) connected to the scale-out network (130), then a relevant DPU (e.g., 125A, FIG. 1.2) would be prioritizing the sending of the non-storage traffic to the target PU over storage traffic (e.g., network traffic transmitting checkpoint data to the storage system).

In contrast, referring to FIG. 1.4, the system (100) may segregate the storage traffic from the non-storage traffic using two different networks/fabrics (e.g., the storage network (132) and the scale-out network (130)), in which the servers (e.g., 140A, 140M, etc.) are connected to both networks. The scale-out network (130) may be used to transmit non-storage traffic (e.g., traffic that is caused by PUs for exchanging AI model training parameters), while the storage network (132) (which may also be a scale-out network or any other type of network) may only transmit storage traffic. In this manner, there may be no connection between the storage traffic and the non-storage traffic associated with the servers (e.g., 140A, 140M, etc.) (and components therein).

In one or more embodiments, to enable the use of two distinct networks, the architecture of the servers (e.g., 140A, 140M, etc.) may be modified. Those skilled in the art will appreciate that while FIG. 1.4 shows one embodiment of a modified server architecture, other modified server architectures may be used without departing from the scope of the embodiments disclosed herein.

Referring to FIG. 1.4, DPUs of each server (e.g., 140A, 140M, etc.) are operatively connected to the storage network (132) and to PUs of the relevant server. The DPUs (e.g., 125A, 125N, etc.) may communicate with the relevant PUs (e.g., 128A, 128N, etc.) via a PCIe fabric (or a high-speed interconnect internal to the server/host) (e.g., 127). Further, the DPUs (e.g., 125A, 125N, etc.) may leverage the corresponding NICs (e.g., 123) connected to the scale-out network (130) through the PCIe fabric (e.g., 127). Once able to access the scale-out network (130), the DPUs (e.g., 125A, 125N, etc.) may use the scale-out network (130) during low-traffic intervals as a fast communication network to implement a distributed caching function.

Further, the system (100) shown in FIG. 1.4 may provide a framework by which DPUs with expanded memory (or DPUs that include local cache (e.g., 126A, 126M, etc.) to temporarily store data for AI model training (or fine-tuning) and/or AI inferencing), connected to the storage network (132), may provide high-speed distributed cache (where each DPU may have a dedicated connection to the storage network (132), which may result in a significantly higher BW among DPUs (e.g., a non-blocking access/path among DPUs) than exists between all the DPUs and the storage system (120)). As discussed above, the size of each cache (e.g., 126A, 126M, etc.) may need to be sized to accommodate at least the amount of data for AI model training (or fine-tuning) and/or AI inferencing (which may or may not be compressed).

While FIG. 1.4 shows a configuration of components, other system configurations may be used without departing from the scope of the embodiments disclosed herein.

In one or more embodiments, the following steps may be executed in each iteration during the training or fine-tuning of an AI model: (i) a batch of training data is fetched from a storage system (e.g., 120, FIG. 1.4) and loaded into a related PU (e.g., 128A, FIG. 1.4), (ii) the batch is then processed by the PU to obtain the model's current prediction, (iii) process/analysis is done to determine how much the prediction deviates from the correct output, and (iv) model parameters (e.g., weights) are updated using computed gradients to correct the deviation. In most cases, most of the time in each iteration should be spent on (ii)-(iv) (i.e., PU compute time). A data stall may occur when the PU is blocked while newer data is retrieved from the storage system in (i). Data stalls may need to be minimized, as they result in idle PU operations, delaying performance of AI workloads and reducing infrastructure ROI.

Further, the rate at which data can be fetched from the storage system (e.g., 120, FIG. 1.4) in (i) may depend primarily on the storage media, the BW between the storage system and the PU, and the latency of transfers between the storage system and the PU, which can be affected by the workload on the storage system and communications between other devices (of the system (100)) consuming network BW on any shared network/fabric (i.e., the noisy neighbor phenomena).

Continuing with the discussion, referring to FIG. 1.1 and 1.4, PUs executing training, inferencing, fine-tuning workloads, or any other workload may communicate across a high-BW network (e.g., the scale-up network (130)), communicating over dedicated NICs (e.g., 123, 124, etc.) or DPUs (e.g., 125A, 125M, etc.) (including each DPU's cache), to (i) minimize data stalls during intra-PU communication (which may be performed using RDMA, HTTPS, or UDP) and (ii) generate distributed cache (that can be used for AI training, inferencing, and/or fine-tuning workloads, along with other workloads that use read-only (or eventually consistent) data and would benefit from the performance offered by cached data). In this manner, the system/framework (100) may (i) provide an effective use of scarce cache (or cache memory), (ii) limit the need for the storage system (120) to transmit duplicate data blocks (of data), and (iii) distribute the data across multiple cache points while (a) leveraging the high-BW offered by the scale-out network (130), (b) reducing the volume of I/O used by the storage system (120), and enabling the storage network (132) to be used without causing a data bottleneck.

In one or more embodiments, the system (100) may enable data to be consumed by a PU (e.g., 128A, 128M, etc.) be cached to cache (e.g., 126A, 126M, etc.) close to the PU. This cache may be located in a DPU (e.g., 125A, 125M, etc.) (or located in a related server's memory) that would allow a rapid transfer of the cache contents to the PU via a PCIe (e.g., 127, 131, etc.) (or an equivalent bus).

In one or more embodiments, the storage system (120) may have a low-BW connection to a network (e.g., 130, 132, etc.) when compared to the overall BW of the network. In addition, the storage system (120) may need to be pulling data from relatively slow components, such as Flash memory. When each data block is sent by the storage system (120), the storage system (120) may record the identifier (e.g., an IP address, a VXLAN identifier, etc.) of a related DPU (e.g., 125A, 125M, etc.) to which each data block is sent, and the DPU may retain a data block in its cache (e.g., 126A, 126M, etc.) until the data block is evicted (by the DPU) to provide space for a more relevant data block.

When another DPU (e.g., 125N, 125Z, etc.) requests the same data block (from the storage system (120)), the storage system may redirect the request to the DPU that is currently holding the data block, eliminating the need for the storage system to provide the data block again (which would be a duplicate data block) using its limited BW. The requesting DPU may use the high-speed, high-BW link between the two DPUs to obtain a copy of the data block without using the limited resources available to the storage system (120).

In one or more embodiments, the storage system (120) may maintain a list of data blocks that are duplicated (in its block-cache table (see FIG. 1.1)). If a given DPU (e.g., 125A, 125M, etc.) requests a data block that is a duplicate of another data block (which is already sent by the storage system (120)), the storage system would provide a reference to the data block already sent to a related DPU (e.g., 125N, 125Z, etc.) rather than sending the duplicate data block. For example, if Block 0 and Block 1 of a file are duplicate data blocks (where the contents of both are binary zero), the storage system (120) may send Block 0 when requested by a related DPU (e.g., 125A, 125M, etc.), and may send a reference to Block 0 when Block 1 is requested (by another DPU). This may further reduce the volume of data that needs to be sent from the storage system (120) in scenarios where data is duplicated, or a sparse data file is being read.

In one or more embodiments, while the framework/system (100) enables the use of additional memory on each DPU (e.g., 125A, 125N, etc.) to provide local and/or distributed cache, the functionalities provided by this manner can also be realized by using, for example, memory of a related server or memory of a ToR switch (see FIG. 1.3). Further, while DPUs attached to the storage network (132) (see FIG. 1.4) can be used to implement the data caching mechanism, the system (100) described in FIG. 1.1 can also be used (as an alternative approach) to implement the data caching mechanism.

In this alternative approach, (i) the storage system (120) is operatively connected to the scale-out network (130), (ii) in each server (e.g., 140A, 140Z, etc.), one or more DPUs (with expanded memory/cache) are operatively connected to the scale-out network (130), and (iii) the data caching mechanism is implemented on each DPU. This approach may provide an incremental intra-DPU BW for accelerated access to cached data. Although PUs may transfer large quantities of data during training, fine-tuning, and/or inferencing workloads, the scale-out network (130) would have time periods when the PUs are processing data and the scale-out network's load is low (so that accelerated access to cached data can be performed without affecting the PUs production workloads).

FIG. 2.1-2.2 show a method for managing data in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

In one or more embodiments, FIG. 2.1-2.3 show three exemplary scenarios (e.g., Sections 1-3) for managing data in a system (e.g., 100, FIG. 1.1) in accordance with one or more of the previously described embodiments. The scenarios described in FIG. 2.1-2.3 are merely for illustrative purposes and are not intended to limit the scope of the embodiments disclosed herein.

Turning now to FIG. 2.1 (for Scenario 1), the method shown in FIG. 2.1 may be executed by, for example, the above-discussed PUs (e.g., GPUs, NPUs, TPUs, CPUs, etc.), DPUs, and storage system (which are operatively connected to each other over a network (e.g., 130, FIG. 1.1)), in which (i) PU A (200A) (which may be a GPU, an NPU, a TPU, a CPU, etc.) and DPU A (202A) may be hosted by a first server (e.g., 140A, FIG. 1.4) and (ii) PU B (200B) (which may be a GPU, an NPU, a TPU, a CPU, etc.) and DPU B (202B) may be hosted by a second server (e.g., 140M, FIG. 1.4). Other components of the system (100) illustrated in FIG. 1.1 (or in FIG. 1.4) may also execute all or part of the method shown in FIG. 2.1 without departing from the scope of the embodiments disclosed herein. In the aforementioned scenarios, one may assume that a data file containing four data blocks (Block 0-3), in which Block 2 is identical to Block 0, and Block 3 is identical to Block 1.

In Step 210, PU A (200A) initially sends a read request for Block 0 to DPU A (202A). Upon receipt of the read request, DPU A (202A) makes a first determination that Block 0 is not present in a first cache of DPU A (202A). In response to the first determination, in Step 212, DPU A (202A) sends/forwards/issues the read request to the storage system (204). Upon receipt of the read request, in Step 214, the storage system (204) makes a second determination that Block 0 is not present in any DPU (including a second cache of DPU B (202B)).

In response to the second determination, in Step 216, the storage system (204) sends Block 0 along with a random (or randomly-generated) authorization token (associated with Block 0) to DPU A (202A). After sending Block 0, the storage system (204) may update its block-cache table (see FIG. 1.1) for the file using an identifier of DPU A (202A) and the random authorization token (associated with Block 0). In one or more embodiments, every time the storage system (204) sends/resends a data block to a DPU, the storage system (204) may generate a newer random authorization token for the data block.

Subsequently, in Step 218, DPU A (202A) stores Block 0 and the token (associated with Block 0) in the first cache of DPU A (202A) until Block 0 needs to be evicted from the first cache. Thereafter, in Step 220 and in response to the read request (received from PU A (200A) in Step 210), DPU A (202A) sends/forwards Block 0 to PU A (200A).

At a later point-in-time, in Step 222, PU A (200A) sends a second read request for Block 1 to DPU A (202A). Upon receipt of the second read request, DPU A (202A) makes a third determination that Block 1 is not present in the first cache of DPU A (202A). In response to the third determination, in Step 224, DPU A (202A) sends the second read request to the storage system (204). Upon receipt of the second read request, in Step 226, the storage system (204) makes a fourth determination that Block 1 is not present in any DPU (including the second cache of DPU B (202B)).

In response to the fourth determination, in Step 228, the storage system (204) sends Block 1 along with a random authorization token (associated with Block 1) to DPU A (202A). After sending Block 1, the storage system (204) may update its block-cache table for the file using the identifier of DPU A (202A) and the random authorization token (associated with Block 1). Subsequently, in Step 230, DPU A (202A) stores Block 1 and the token (associated with Block 1) in the first cache of DPU A (202A) until Block 1 needs to be evicted from the first cache. Thereafter, in Step 232 and in response to the second read request (received from PU A (200A) in Step 222), DPU A (202A) sends Block 1 to PU A (200A).

Turning now to FIG. 2.2 (for Scenarios 1-2), the method shown in FIG. 2.2 may be executed by, for example, the above-discussed PUs (e.g., GPUs, NPUs, TPUs, CPUs, etc.), DPUs, and storage system, in which (i) PU A (200A) (which may be a GPU, an NPU, a TPU, a CPU, etc.) and DPU A (202A) may be hosted by the first server and (ii) PU B (200B) (which may be a GPU, an NPU, a TPU, a CPU, etc.) and DPU B (202B) may be hosted by the second server. Other components of the system (100) illustrated in FIG. 1.1 (or in FIG. 1.4) may also execute all or part of the method shown in FIG. 2.2 without departing from the scope of the embodiments disclosed herein.

At a later point-in-time, in Step 234, PU A (200A) sends a third read request for Block 2 to DPU A (202A). Upon receipt of the third read request, DPU A (202A) makes a fifth determination that Block 2 is not present in the first cache of DPU A (202A). In response to the fifth determination, in Step 236, DPU A (202A) sends the third read request to the storage system (204). Upon receipt of the third read request, in Step 238, the storage system (204) makes a sixth determination that Block 2 is identical to Block 0 and Block 0 is present in the first cache of DPU A (202A).

In response to the sixth determination, in Step 240, the storage system (204) sends a message (e.g., a “failure: in-cache” message) to DPU A (202A), in which the message may specify the identifier of DPU A (202A) and a random authorization token (associated with Block 0). Upon receipt of the message (or based on the message) and in response to the third read request (received from PU A (200A) in Step 234), in Step 242, DPU A (202A) sends Block 0 (as Block 2) to PU A (200A), which treats Block 0 as Block 2. In one or more embodiments, the method (relevant to Scenario 1) may end following Step 242.

As indicated above, in Scenario 1, the duplicate data blocks need not to be passed over the I/O ports of the storage system (204), and the saving in the I/O BW may be used to accelerate other storage I/O processes (e.g., providing data to DPU A (202A)).

Continuing with the discussion of FIG. 2.2, in Scenario 2, a corresponding DPU's cache can be used to serve data to other DPUs in the system, enabling a further reduction in a storage I/O volume (even in scenarios where data blocks are not duplicated).

In Step 244, PU B (200B) sends a read request for Block 1 to DPU B (202B). Upon receipt of the read request, in Step 246, DPU B (202B) makes a first determination that Block 1 is not present in the second cache of DPU B (202B). In response to the first determination, in Step 248, DPU B (202B) sends the read request to the storage system (204). Upon receipt of the read request, the storage system (204) makes a second determination that Block 1 is present in the first cache of DPU A (202A).

In response to the second determination, in Step 250, the storage system (204) sends a message (e.g., a “failure: in-cache” message) to DPU B (202B), in which the message may specify the identifier of DPU A (202A) (which is the DPU that last received Block 1) and the random authorization token (associated with Block 1) that is retrieved from the block-cache table. Upon receipt of the message, in Step 252, DPU B (202B) sends the read request for a copy of Block 1 (along with the authorization token (associated with Block 1)) to DPU A (202A).

Upon receipt of the read request and the authorization token (associated with Block 1), DPU A (202A) performs a verification as to whether the received token matches the token that is related to Block 1. After verifying the received token, in Step 254, DPU A (202A) sends Block 1 to DPU B (202B). In one or more embodiments, the interaction between DPU A (202A) and DPU B (202B) does not have to use storage semantics, as this interaction is a memory related data transfer. For this reason, a remote DMA or other relevant data transfer protocols may be used to facilitate the interaction. Thereafter, in Step 256 and in response to the read request (received from PU B (200B) in Step 244), DPU B (202B) sends Block 1 to PU B (200B). In one or more embodiments, the method (relevant to Scenario 2) may end following Step 256.

As indicated above, in Scenario 2, data blocks that are already in a DPU cache need not to be passed over constrained I/O connections of the storage system (204), and the saving in the I/O BW may be used to accelerate other storage I/O processes (e.g., providing data to DPU B (202B)).

Turning now to FIG. 2.3 (for Scenario 3), the method shown in FIG. 2.3 may be executed by, for example, the above-discussed PUs (e.g., GPUs, NPUs, TPUs, CPUs, etc.), DPUs, and storage system, in which (i) PU A (200A) (which may be a GPU, an NPU, a TPU, a CPU, etc.) and DPU A (202A) may be hosted by the first server and (ii) PU B (200B) (which may be a GPU, an NPU, a TPU, a CPU, etc.) and DPU B (202B) may be hosted by the second server. Other components of the system (100) illustrated in FIG. 1.1 (or in FIG. 1.4) may also execute all or part of the method shown in FIG. 2.3 without departing from the scope of the embodiments disclosed herein.

In Step 258, PU B (200B) sends a read request for Block 0 to DPU B (202B). Upon receipt of the read request, in Step 260, DPU B (202B) makes a first determination that Block 0 is not present in the second cache of DPU B (202B). In response to the first determination, in Step 262, DPU B (202B) sends the read request to the storage system (204). Upon receipt of the read request, the storage system (204) makes a second determination that Block 0 is present in the first cache of DPU A (202A).

In response to the second determination, in Step 264, the storage system (204) sends a message (e.g., a “failure: in-cache” message) to DPU B (202B), in which the message may specify the identifier of DPU A (202A) (which is the DPU that last received Block 0) and the random authorization token (associated with Block 0) that is retrieved from the block-cache table. Upon receipt of the message, in Step 266, DPU B (202B) sends the read request (along with the authorization token (associated with Block 0)) for a copy of Block 0 to DPU A (202A).

Upon receipt of the read request and the authorization token (associated with Block 0), in Step 268, DPU A (202A) sends a second message to DPU B (202B) indicating that Block 0 has been evicted from the first cache of DPU A (202A). Upon receipt of the second message, in Step 270, DPU B (202B) sends a third message to the storage system (204) to indicate that Block 0 is no longer in the first cache and to request Block 0 from the storage system (204).

Upon receipt of the third message, in Step 272, the storage system (204) sends Block 0 along with a newly-generated random authorization token (associated with Block 0) to DPU B (202B). Thereafter, based on the newly-generated random authorization token (and the identifier of DPU B (202B)), the storage system (204) may update the block-cache table for the file to keep the table up-to-date. Subsequently, in Step 274, DPU B (202B) stores Block 0 and the token (associated with Block 0) in the second cache of DPU B (202B) until Block 0 needs to be evicted from the second cache. Thereafter, in Step 276 and in response to the read request (received from PU B (200B) in Step 258), DPU B (202B) sends Block 0 to PU B (200B). In one or more embodiments, the method (relevant to Scenario 3) may end following Step 276.

In one or more embodiments, data (or data blocks) in a related DPU cache (e.g., 126A, FIG. 1.2) can be evicted using a set of models/algorithms. For example, the Least Recently Used (LRU) model may be used, in which the LRU model may optionally include or discard requests from other DPUs in determining when a cache entry was last used. As yet another example, an “inferred” model may be used, in which, with the help of the inferred model, a corresponding DPU may identify data access sequences for a particular data block. In this manner, those sequences may be used to pre-load training (or fine-tuning) data and to predict cache access patterns (so that the cache management service (of the DPU) can be informed about which data block are more likely to be read again).

As yet another example, a “timed” model may be used to evict a cache entry after a pre-determined amount of time. This model may be used for AI inferencing workloads in which stored data can change over time.

While stale data can be tolerated by AI inferencing workloads for a period of time, as a small number of changes are unlikely to have a significant impact, at some point-in-time, the related cache should be marked as expired to ensure that AI inferencing workloads always use a close-to-current version of data. While implementing the timed model, a corresponding DPU may ask the storage system for a fingerprint of a related data block that is about to expire. If the fingerprint from the storage system matches the fingerprint of the data block that is held in the cache (of the DPU), the DPU may infer that there has been no change in the data block and the cache timer can be reset without the overhead of re-reading the data block (e.g., from the storage system).

In one or more embodiments, if a first DPU is unable to read a cached data block from a second DPU that holds the data block (e.g., because the first DPU cannot communicate with the second DPU), the first DPU may request the data block from the storage system (e.g., 120, FIG. 1.1) in a manner similar to the process used when the data block has been evicted from a related DPU's cache.

As discussed above, each DPU (of the system (e.g., 100, FIG. 1.1)) intending to read, for example, a data block from the storage system (e.g., 120, FIG. 1.1) may first be authorized for access to the data block. While caching a data block, authorization of a DPU can be implemented in two ways. In the first way, each DPU can become part of the authentication/authorization mechanism, requiring all other DPUs desiring to read cached data blocks to be first authenticated by the DPU holding the cached data blocks. In the second way, when the storage system sends a data block to a related DPU, the storage system would generate an authorization token, which is a large random value that is unlikely to be guessed by a rogue actor. The storage system may (i) add that token to the block-cache table for a corresponding file and (ii) send that token to the DPU along with the requested data block. Thereafter, the DPU may add that token to its data block directory when the DPU adds the data block to its cache.

Further, in the second way, when a DPU (the requesting DPU) requests a data block that is already in the cache of another DPU (the holding DPU), the storage system may provide the authorization token (related to the data block) in a message sent to the requesting DPU, in which the storage system may retrieve the token from its block-cache table. Thereafter, the requesting DPU may present the token to the holding DPU along with the identifier of the requested data block. The holding DPU may verify the token and return the requested data block only if the token is verified. A DPU can only obtain a valid authorization token for a data block by first requesting that data block from the storage system, and the DPU can only make that request after being authenticated by the storage system. Thus, a DPU may first be authenticated by the storage system to retrieve the related authorization token that would allow DPU to request a related data block from another DPU. Further, to prevent replay attacks on an authorization token, the storage system may generate a newer authorization token for a data block every time the storage system needs to send a data block to a DPU.

Turning now to FIG. 3, FIG. 3 shows a diagram of a computing device in accordance with one or more embodiments disclosed herein.

In one or more embodiments disclosed herein, the computing device (300) may include one or more computer processors (302), non-persistent storage (304) (e.g., volatile memory, such as RAM, cache memory), persistent storage (306) (e.g., a non-transitory computer readable medium, a hard disk, an optical drive such as a CD drive or a DVD drive, a Flash memory, etc.), a communication interface (312) (e.g., Bluetooth interface, infrared interface, network interface, optical interface, etc.), an input device(s) (310), an output device(s) (308), and numerous other elements (not shown) and functionalities. Each of these components is described below.

In one or more embodiments, the computer processor(s) (302) may be an integrated circuit for processing instructions. For example, the computer processor(s) (302) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (e.g., a LAN, a WAN, Internet, mobile network, etc.) and/or to another device, such as another computing device.

In one or more embodiments, the computing device (300) may include one or more output devices (308), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing data, the method comprising:
sending, by a processing unit (PU) of a first server, a read request for a data block of a file to a first data processing unit (DPU) of the first server;
making, by the first DPU and upon receiving the read request, a first determination that the data block is not present in a first cache of the first DPU;
sending, by the first DPU and based on the first determination, the read request to a storage system (SS), wherein the first server, a second server, and the SS are operatively connected to each other over a network;
making, by the SS and upon receiving the read request, a second determination that the data block is not present in a second cache of a second DPU of the second server;
sending, by the SS and based on the second determination, the data block along with an authorization token to the first DPU,
wherein, after sending the data block, the SS updates a block-cache table for the file using an identifier of the first DPU and the token;
storing, by the first DPU, the data block and the token to the first cache until the data block needs to be evicted from the first cache; and
sending, by the first DPU and in response to the read request, the data block to the PU.

2. The method of claim 1,
wherein each data block in the table is represented with a single record,
wherein each record comprises a first field and a second field,
wherein the first field specifies a second identifier of a related DPU to which the SS has sent the data block, and
wherein the second field specifies a second authorization token to be used to ensure that only authorized DPUs would be able to access the data block from the first cache.

3. The method of claim 1,
wherein the first DPU comprises the first cache and a data block directory for each file, and
wherein the data block directory specifies a second identifier of the data block, location information of the data block in the first cache, and the authorization token.

4. The method of claim 1, wherein the SS generates the authorization token.

5. The method of claim 1, wherein the data block is part of training data that the PU needs to use while training a model.

6. The method of claim 1, wherein the PU and the first DPU are operatively connected to each other over a peripheral component interconnect express (PCIe).

7. The method of claim 1,
wherein the network is a scale-out network, and
wherein the PU is a graphics processing unit (GPU), a neural processing unit (NPU), a tensor processing unit (TPU), or a central processing unit (CPU).

8. A method for managing data, the method comprising:
sending, by a processing unit (PU) of a first server, a read request for a data block of a file to a first data processing unit (DPU) of the first server;
making, by the first DPU and upon receiving the read request, a first determination that the data block is not present in a first cache of the first DPU;
sending, by the first DPU and based on the first determination, the read request to a storage system (SS);
making, by the SS and upon receiving the read request, a second determination that the data block is present in a second cache of a second DPU of a second server;
sending, by the SS and based on the second determination, a message to the first DPU,
wherein the message specifies an identifier of the second DPU and a related authorization token;
sending, by the first DPU and upon receiving the message, the read request along with the related authorization token to the second DPU,
wherein the first server, the second server, and the SS are operatively connected to each other over a network;
sending, by the second DPU and after verifying the related authorization token, the data block to the first DPU; and
sending, by the first DPU and in response to the read request, the data block to the PU.

9. The method of claim 8,
wherein the SS comprises a block-cache table for the file,
wherein each data block in the table is represented with a single record,
wherein each record comprises a first field and a second field,
wherein the first field specifies the identifier of the second DPU to which the SS has sent the data block, and
wherein the second field specifies the related authorization token to be used to ensure that only authorized DPUs would be able to access the data block from the second cache.

10. The method of claim 8,
wherein the second DPU comprises the second cache and a data block directory for each file, and
wherein the data block directory specifies a second identifier of the data block, location information of the data block in the second cache, and the related authorization token.

11. The method of claim 8, wherein the SS generates the related authorization token.

12. The method of claim 8, wherein the data block is part of inferencing data that the PU needs to analyze.

13. The method of claim 8, wherein the PU and the first DPU are operatively connected to each other over a peripheral component interconnect express (PCIe).

14. The method of claim 8,
wherein the network is a scale-out network, and
wherein the PU is a graphics processing unit (GPU), a neural processing unit (NPU), a tensor processing unit (TPU), or a central processing unit (CPU).

15. A method for managing data, the method comprising:
sending, by a processing unit (PU) of a first server, a read request for a data block of a file to a first data processing unit (DPU) of the first server;
making, by the first DPU and upon receiving the read request, a first determination that the data block is not present in a first cache of the first DPU;
sending, by the first DPU and based on the first determination, the read request to a storage system (SS);
making, by the SS and upon receiving the read request, a second determination that the data block is present in a second cache of a second DPU of a second server;
sending, by the SS and based on the second determination, a message to the first DPU,
wherein the message specifies an identifier of the second DPU and a related authorization token;
sending, by the first DPU and upon receiving the message, the read request along with the related authorization token to the second DPU,
wherein the first server, the second server, and the SS are operatively connected to each other over a network;
sending, by the second DPU and in response to the read request, a second message to the first DPU indicating that the data block is evicted from the second cache;
sending, by the first DPU and based on the second message, a third message to the SS to indicate that the data block is no longer in the second cache;
sending, by the SS and based on the third message, the data block along with an authorization token to the first DPU;
storing, by the first DPU, the data block and the token to the first cache until the data block needs to be evicted from the first cache; and
sending, by the first DPU and in response to the read request, the data block to the PU.

16. The method of claim 15,
wherein the network is a scale-out network, and
wherein the PU is a graphics processing unit (GPU), a neural processing unit (NPU), a tensor processing unit (TPU), or a central processing unit (CPU).

17. The method of claim 15, wherein the PU and the first DPU are operatively connected to each other over a peripheral component interconnect express (PCIe).

18. The method of claim 15, wherein the data block is part of fine-tuning data that the PU needs to use while training a model.

19. The method of claim 15, wherein the SS generates the authorization token.

20. The method of claim 15,
wherein the first DPU comprises the first cache and a data block directory for each file, and
wherein the data block directory specifies a second identifier of the data block, location information of the data block in the first cache, and the authorization token.
